(19) United States
(12) Patent Application Publication
(10) Pub. No.: US 2011/0090673 A1
(43) Pub. Date: Apr. 21, 2011

(54) Multi-function illuminating device

(76) Inventor: Leo Shih, Taichung (TW)

(21) Appl. No.: 12/603,267

(22) Filed: Oct. 21, 2009

(51) Int. Cl. B25B 23/18

(52) U.S. Cl. 362/119

(57) ABSTRACT

A multi-function illuminating device comprises a body including a light member disposed on a front end thereof and a button and a cell assembly, both of which electrically connect with the light member, and the switch being used to start and stop the light member, the body also including a cover mounted on a rear end thereof, characterized in that: the cover includes a fitting portion extending from a rear end thereof, and the fitting portion is formed in a polygonal shank shape to be fitted to a tool.

### BACKGROUND OF THE INVENTION

1. Field of the Invention

The present invention relates to a multi-function illuminating device that is portable and adapted for various conditions based on different requirements.

2. Description of the Prior

Referring to FIG. 1, an illuminating device 10 includes a shank 11 having a light member 12 disposed on a front end of the shank 11, and having a handle 13 mounted on a rear end of the shank 12 so that the light member 12 of the shank 11 is inserted to a gap to illuminate objects, however, such illuminating device 10 is only used in illuminating field.

As shown in FIG. 2, TW Pat. No. 089204030 discloses an illuminating device 20 including a handle 21 having a transparent mount 211 disposed on a front end of the handle 21, and the transparent mount 211 includes a stem 22 mounted on a front end thereof and a receiving member 23 fixed thereon, the receiving member 23 includes a plurality of slots 231 to insert bits 24, and the handle 21 includes an illuminating light 25 secured therein to be started as operating the illuminating light 25 to make light through the transparent mount 211 of the handle 21. However, such illuminating device 20 has the following disadvantages:

1. The illuminating light 25 is only used in illuminating field.

2. The illuminating light 25 can not illuminate objects clearly if it is stopped by some obstructions.

3. The light generating from the illuminating light 25 is stopped by the bits 24 of the receiving member 23.

The present invention has arisen to mitigate and/or obviate the afore-described disadvantages.

### SUMMARY OF THE INVENTION

The primary object of the present invention is to provide a multi-function illuminating device that is portable and adapted for various conditions based on different requirements.

A multi-function illuminating device according to a preferred embodiment of the present invention comprises:

a body including a light member disposed on a front end thereof and a button and a cell assembly, both of which electrically connect with the light member, and the switch being used to start and stop the light member, the body also including a cover mounted on a rear end thereof, characterized in that:

the cover includes a fitting portion extending from a rear end thereof, and the fitting portion is formed in a polygonal shank shape to be fitted to a tool;

wherein the light member is a LED light.

wherein between the cover and the body is defined a coupling structure to be covered to the rear end of the body.

wherein the coupling structure includes inner threads fixed on an inner wall of the rear end of the body, and includes outer threads arranged on a front end of the cover to screw with the inner threads.

wherein the cover includes a spring disposed on the front end thereof to abut against the cell assembly so that the cell assembly electrically connects with the button.

wherein the fitting portion includes a biasing ball secured on one side thereof.

### BRIEF DESCRIPTION OF THE DRAWINGS

FIG. 1 is a perspective view showing the assembly of a conventional illuminating device;

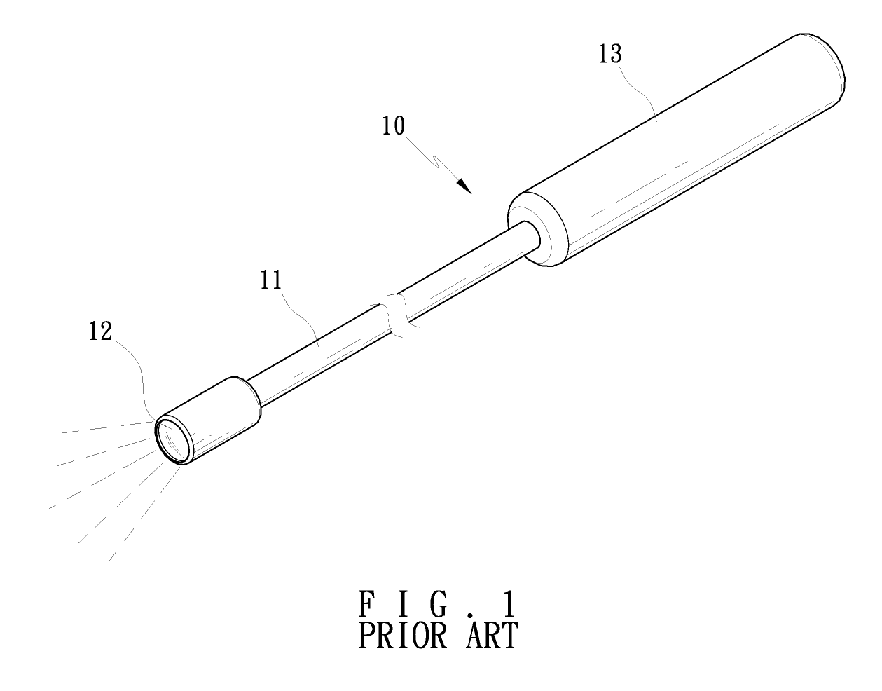

FIG. 2 is a cross sectional view showing the operation of TW Pat. No. 089204030;

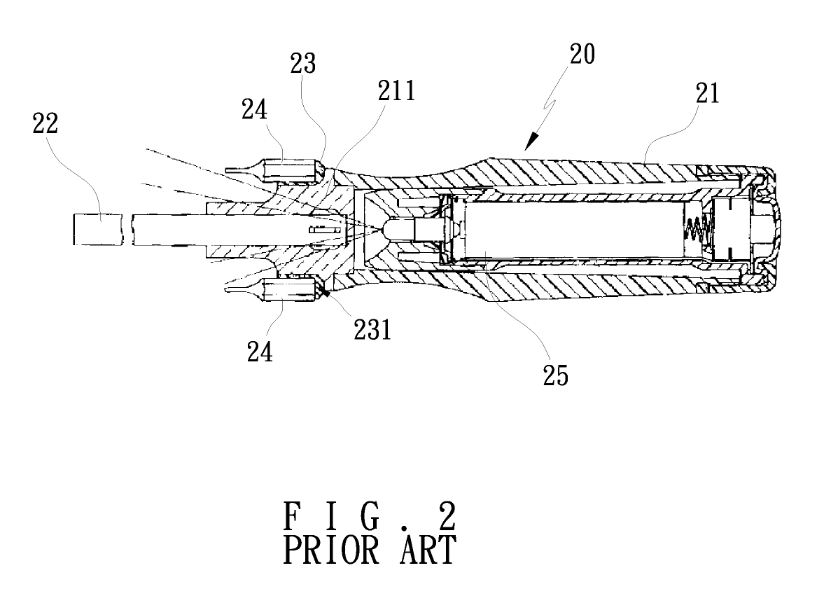

FIG. 3 is a perspective view showing the exploded components of a multi-function illuminating device in accordance with a preferred embodiment of the present invention;

FIG. 4 is a perspective view showing the assembly of the multi-function illuminating device in accordance with the preferred embodiment of the present invention;

FIG. 5 is a perspective view showing the operation of the multi-function illuminating device in accordance with the preferred embodiment of the present invention;

FIG. 6 is another perspective view showing the operation of the multi-function illuminating device in accordance with the preferred embodiment of the present invention;

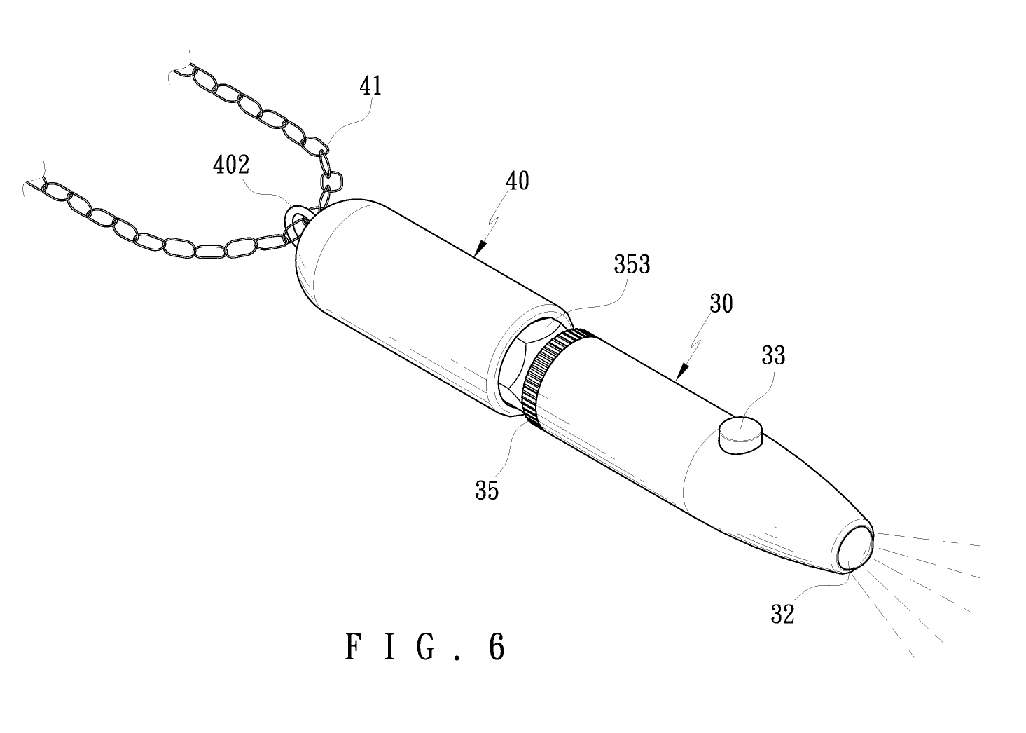

FIG. 7 is a perspective view showing the multi-function illuminating device matching with a driver tool;

FIG. 8 is another perspective view showing the multi-function illuminating device matching with a driver tool;

FIG. 9 is another perspective view showing the multi-function illuminating device matching with a driver tool;

FIG. 10 is another perspective view showing the multi-function illuminating device matching with a driver tool;

FIG. 11 is a perspective view showing the multi-function illuminating device matching with a retractable tool set;

FIG. 12 is another perspective view showing the multi-function illuminating device matching with a retractable tool set.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

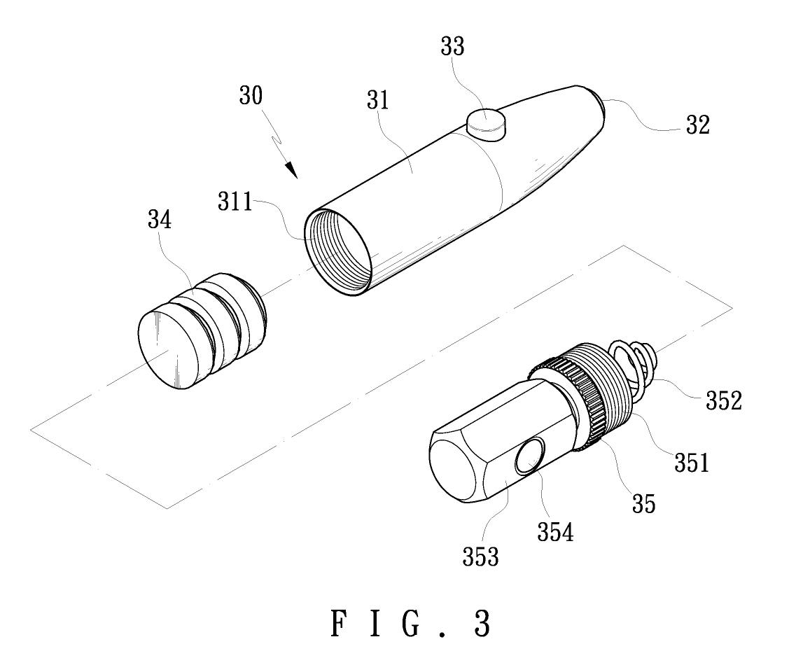

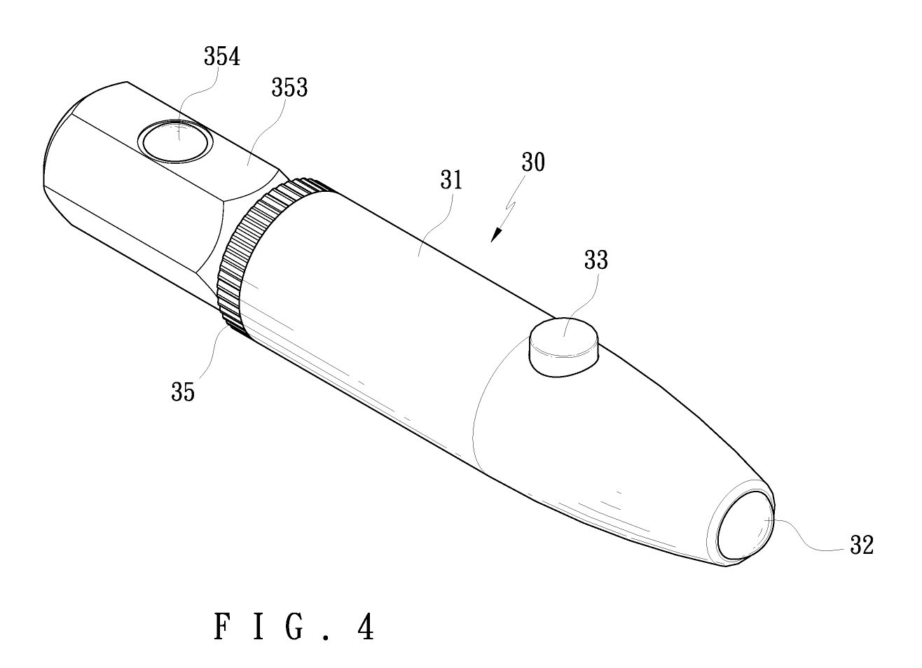

Referring to FIGS. 3 and 4, a multi-function illuminating device 30 according to a preferment embodiment of the present invention comprises: a body 31 including a light member 32 (such as a LED light) disposed on a front end thereof and including a button 33 and a cell assembly 34, both of which are received in the body 31 and electrically connected with the light member 32, wherein the button 33 extends out of the body 31 to start or stop the light member 32, and the body 31 includes a cover 35 mounted on a rear end thereof, between the cover 35 and the body 31 is defined a coupling structure which includes inner threads 311 fixed on an inner wall of the rear end of the body 31, and includes outer threads 351 arranged on a front end of the cover 35 to screw with the inner threads 311. The cover 35 includes a cell assembly 34 attached on the front end thereof to abut against a spring 352 so that the cell assembly 34 electrically connects with the button 33, and includes a fitting portion 353 extends from a rear end thereof to be fitted to a shank 52, wherein the fitting portion 353 is formed in a polygon shape and includes a biasing ball 354 secured on one side thereof.

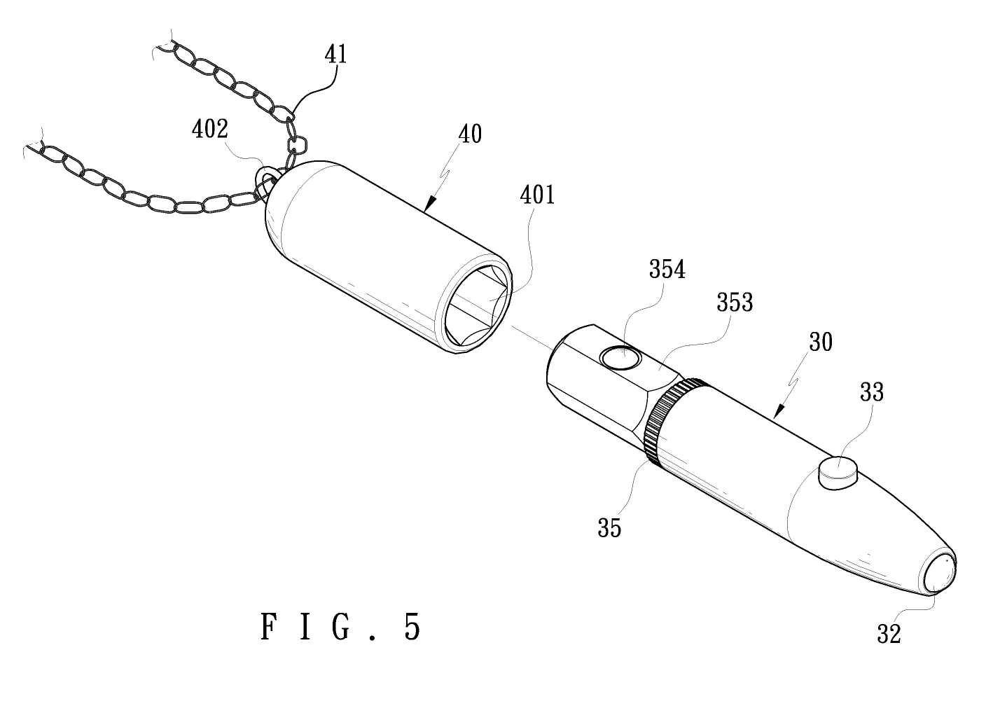

Referring to FIG. 5 and wherein the connector 40 includes a polygonal coupling segment 401 disposed on one end thereof to be fitted to the fitting portion 353 of the cover 35, and includes a loop 402 mounted on another end thereof to insert a chain 41 therethrough so that the illuminating device 3 is portable easily.

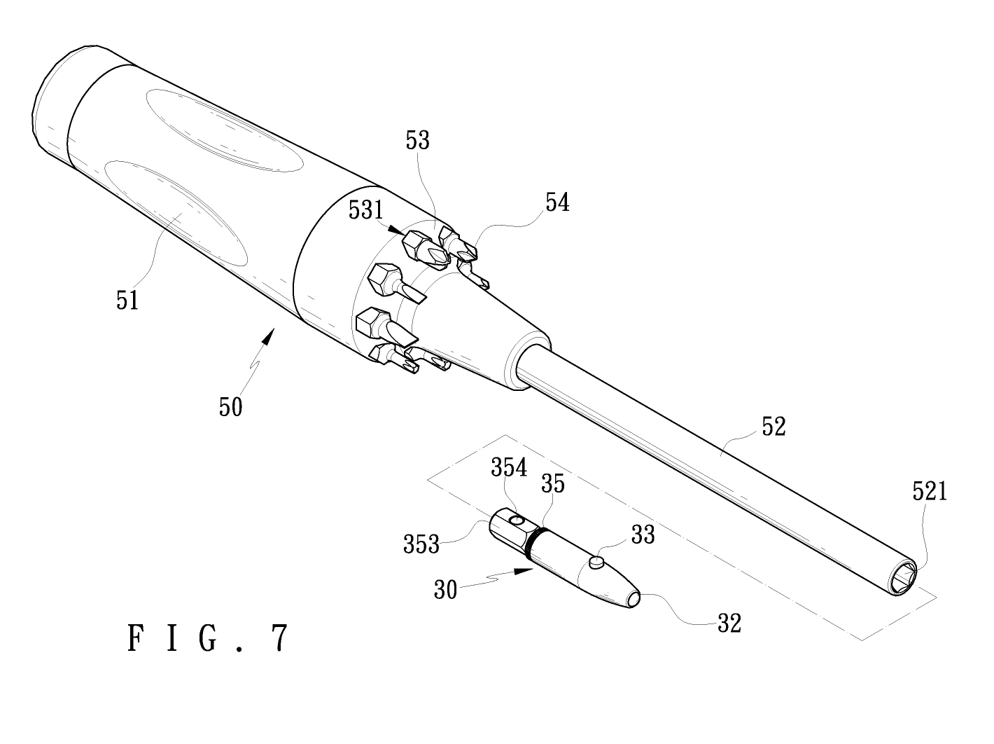

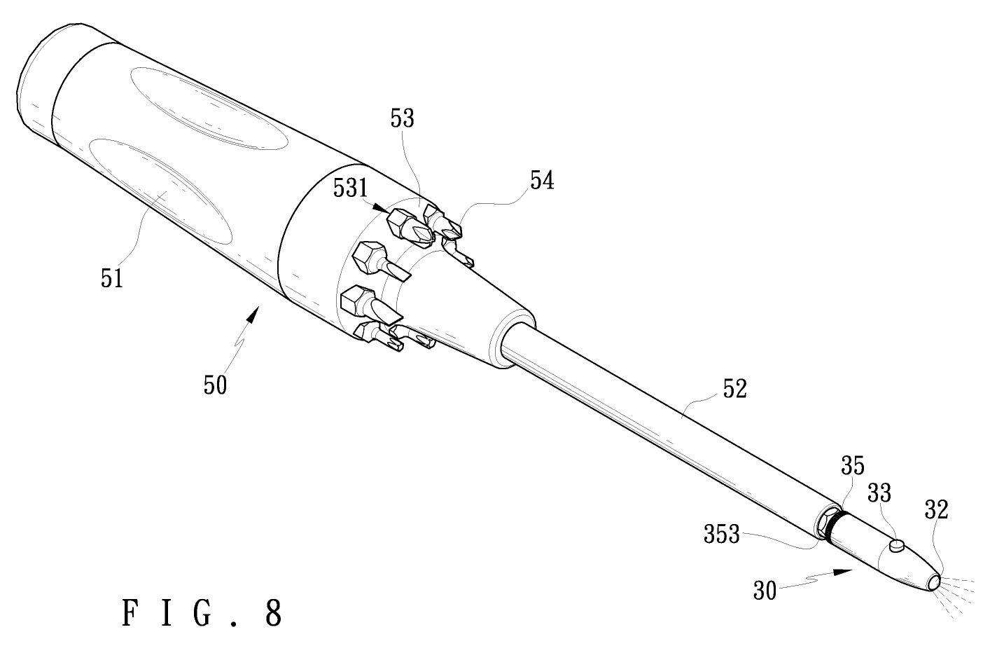

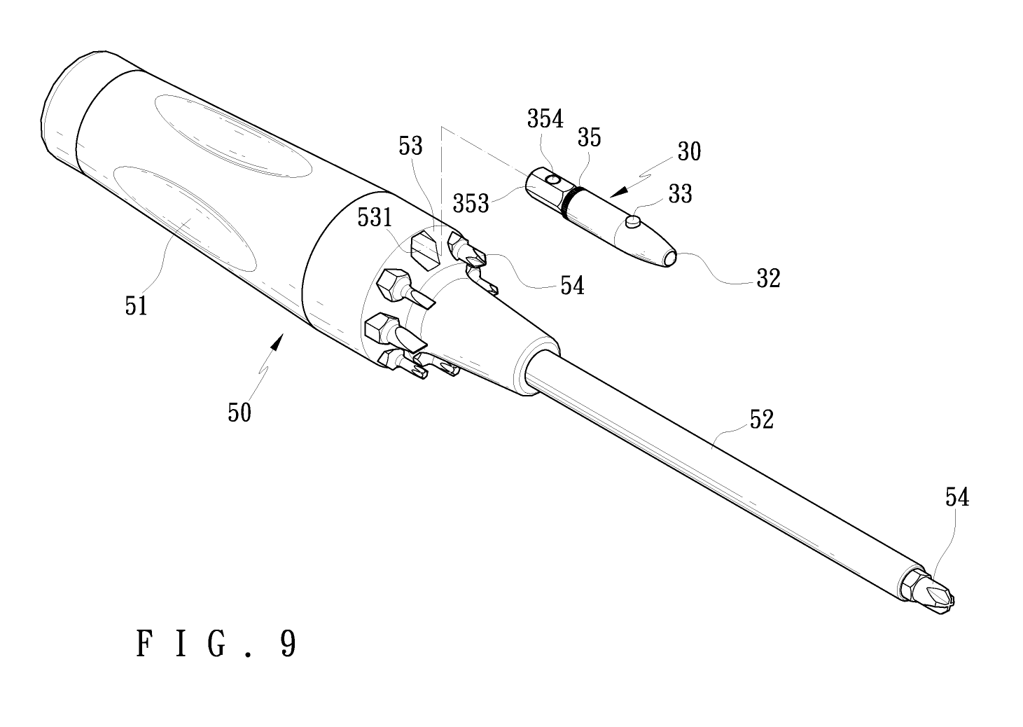

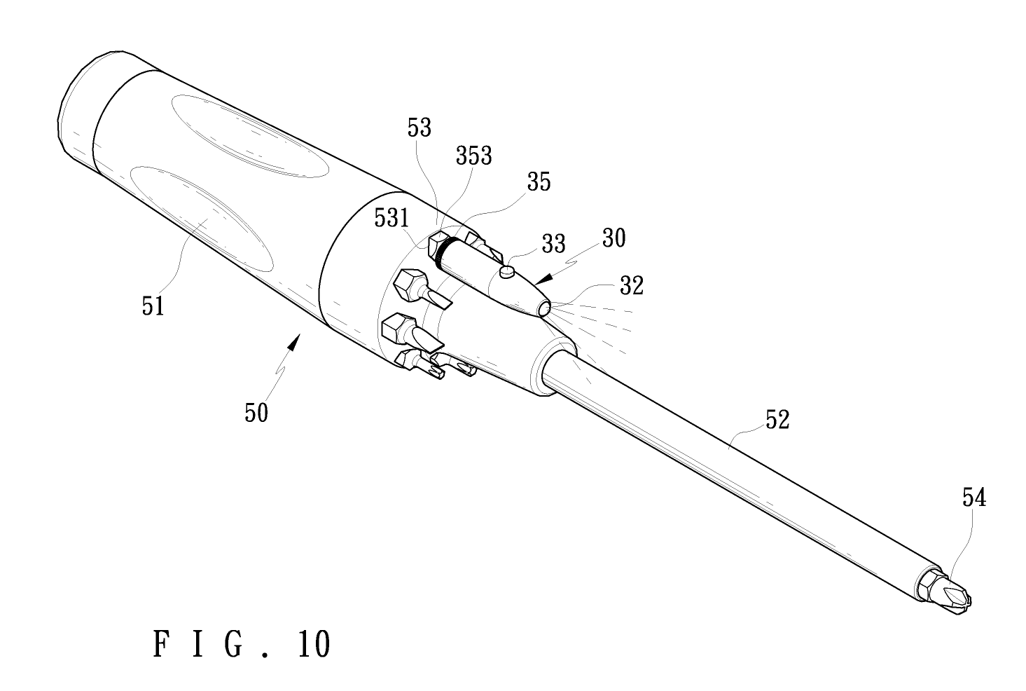

As shown in FIGS. 7 and 8, the illuminating device 30 allows to cooperate with a driver tool 50, wherein the driver tool 50 includes a handle 51 having the shank 52 fixed on a front end of the handle 51, and the shank 52 includes a polygonal coupling segment 521 secured on a front end thereof, the handle 51 includes a pedestal 53 disposed on a front end thereof and having a plurality of slots 531 mounted on an end surface of the pedestal 53 to insert bits 54 respectively. When using the illuminating device 30, the fitting portion 353 of the cover 35 is fitted to the coupling segment 521, and the button 33 is pressed to start the light member 32. Thereafter, the illuminating device 30 is inserted to a narrow gap to have a further illumination to see workpieces clearly. As illustrated in FIGS. 9 and 10, in a disassembling process, if the light is not bright enough, the fitting portion 353 of the cover 35 is inserted to the slot 531 of the pedestal 53, and the light member 32 is started to make illumination to facilitate disassembling process.

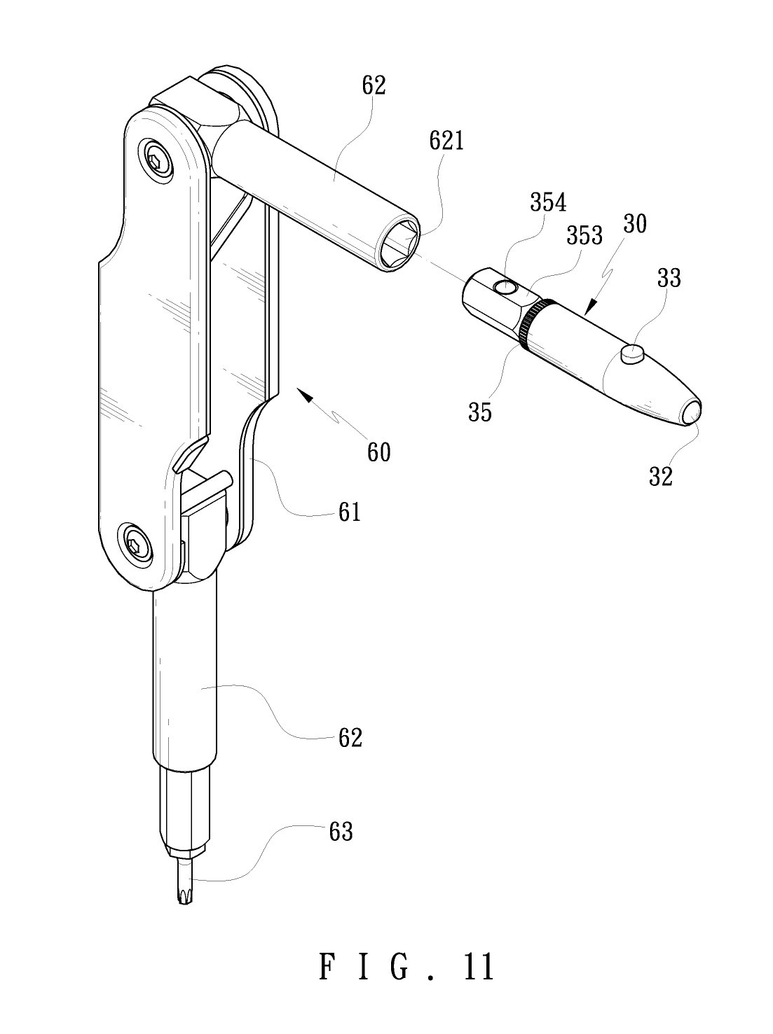

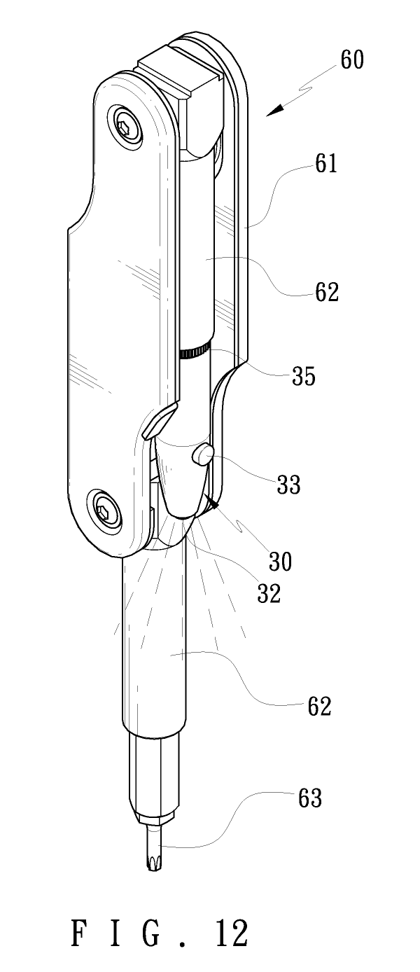

With reference to FIGS. 11 and 12, the illuminating device 30 allows to match with a retractable tool set 60, wherein the tool set 60 includes two shanks 62 disposed on two sides of a body 61 individually, and the shank 62 includes a polygonal coupling segment 621 mounted on an end portion thereof to fit a bit 63, the fitting portion 53 of the cover 35 is inserted to the coupling segment 621 of the shank 62, and then the button 33 is pressed to start the light member 32, making illumination to facilitate disassembling process.

Thereby, the illuminating device is portable and adapted for various conditions based on different requirements.

While we have shown and described various embodiments in accordance with the present invention, it is clear to those skilled in the art that further embodiments may be made without departing from the scope of the present invention.

What is claimed is:

1. A multi-function illuminating device comprising:
a body including a light member disposed on a front end thereof and a button and a cell assembly, both of which electrically connect with the light member, and the switch being used to start and stop the light member, the body also including a cover mounted on a rear end thereof, characterized in that:
the cover includes a fitting portion extending from a rear end thereof, and the fitting portion is formed in a polygonal shank shape to be fitted to a tool.

2. The multi-function illuminating device as claimed in claim 1, wherein the light member is a LED light.

3. The multi-function illuminating device as claimed in claim 1, wherein between the cover and the body is defined a coupling structure to be covered to the rear end of the body.

4. The multi-function illuminating device as claimed in claim 3, wherein the coupling structure includes inner threads fixed on an inner wall of the rear end of the body, and includes outer threads arranged on a front end of the cover to screw with the inner threads.

5. The multi-function illuminating device as claimed in claim 1, wherein the cover includes a spring disposed on the front end thereof to abut against the cell assembly so that the cell assembly electrically connects with the button.

6. The multi-function illuminating device as claimed in claim 1, wherein the fitting portion includes a biasing ball secured on one side thereof.
